(19) United States
(12) Patent Application Publication
(10) Pub. No.: US 2005/0029712 A1
(43) Pub. Date: Feb. 10, 2005

(54) Continuous production of container preforms

(76) Inventors: Thomas E. Nahill, Amherst, NH (US); Bassam M. Kalmouni, Pembroke, NH (US); Keith J. Barker, Candia, NH (US); Brian A. Lynch, Merrimack, NH (US); Nikhil Mani, Billerica, MA (US)

Correspondence Address: OWENS-ILLINOIS, INC., ONE SEAGATE, 25-LDP, TOLEDO, OH, 43666, US

(21) Appl. No.: 10/634,707

(22) Filed: Aug. 5, 2003

(51) Int. Cl. B29C 49/00

(52) U.S. Cl. 264/524; 264/319

(57) ABSTRACT

A method of producing preforms for blow molding containers includes producing polyester polymer by melt phase polymerization and compression molding preforms of the polyester polymer without solidifying the polyester polymer prior to compression molding the preforms. This process has the advantage of eliminating the conventional intermediate steps of solidifying the polymer in the form of pellets, shipping the pellets to the preform manufacturer and then remelting the polymer. Furthermore, because the preforms are produced directly from melt phase polymer, the polymer can have a low intrinsic viscosity of 0.65 or less, which is particularly useful for blow molding containers for low pressure, low temperature applications.

The present invention is directed to preforms for blow molding plastic containers, and more particularly to a process for continuous production of plastic preforms from polyester polymer in melt phase without solidifying the polyester polymer prior to molding the preform.

### BACKGROUND AND SUMMARY OF THE INVENTION

Preforms for blow molding hollow plastic containers typically are produced in batch processes in which one or more solid phase polymers such as polyethylene terephthalate (PET) are melted and injected into preform molds. A general object of the present invention is to provide a method of producing preforms in which the preforms are produced in a continuous process from a flow of polymer in melt phase without solidifying the polymer prior to making the preform.

A method of producing preforms for blow molding containers in accordance with a first aspect of the present invention includes producing polyester polymer by melt phase polymerization and compression molding preforms of the polyester polymer without solidifying the polyester polymer prior to compression molding the preforms. This process has the advantage of eliminating the conventional intermediate steps of solidifying the polymer in the form of pellets, shipping the pellets to the preform manufacturer and then remelting the polymer. Furthermore, because the preforms are produced directly from melt phase polymer, the polymer can have a low intrinsic viscosity of 0.65 or less, which is particularly useful for blow molding containers for low pressure, low temperature applications such as personal care or dry food products.

A method of producing preforms for blow molding containers in accordance with a particularly preferred embodiment of the invention includes producing a continuous flow of polyester resin by melt phase polymerization and dividing the continuous flow into individual compression mold charges in melt phase. A continuous stream of compression mold cavities is provided, and the individual mold charges are placed in associated mold cavities. The mold charges are compression molded into individual preforms, such that there is a continuous flow of polyester polymer to produce a continuous flow of preforms.

### BRIEF DESCRIPTION OF THE DRAWINGS

The invention, together with additional objects, features, advantages and aspects thereof, will be best understood from the following description, the appended claims and the accompanying drawings, in which:

FIG. 1 is a flow diagram that illustrates a process for producing filled and capped blow molded containers, which includes compression molding preforms in accordance with the present invention;

FIGS. 2A and 2B illustrate operation of a mold cavity for compression molding preforms in accordance with an exemplary embodiment of the invention;

FIG. 3 is a side elevational view of an exemplary preform manufactured in accordance with the present invention;

FIG. 3A is a fragmentary sectional view of the portion of the preform within the area 3A in FIG. 3;

FIG. 3B is a fragmentary sectional view that illustrates a modification to the embodiment of FIG. 3A; and

FIG. 4 is a side elevational view of a blow molded container in accordance with one exemplary embodiment of the invention.

### DETAILED DESCRIPTION OF PREFERRED EMBODIMENTS

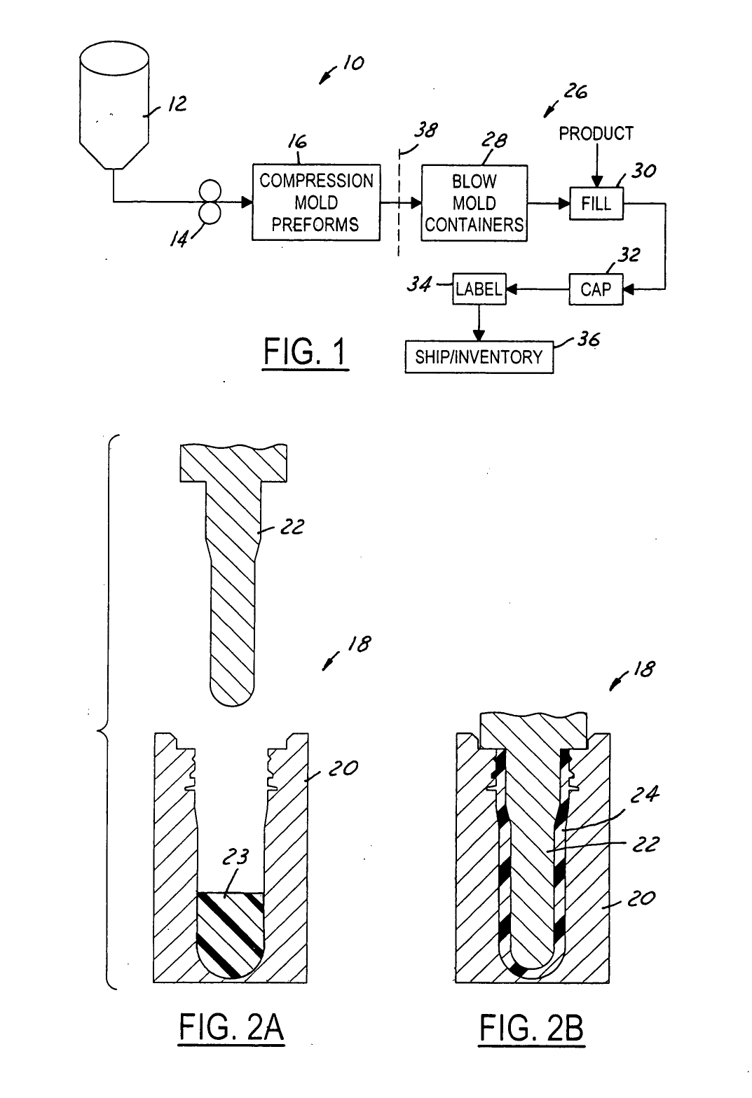

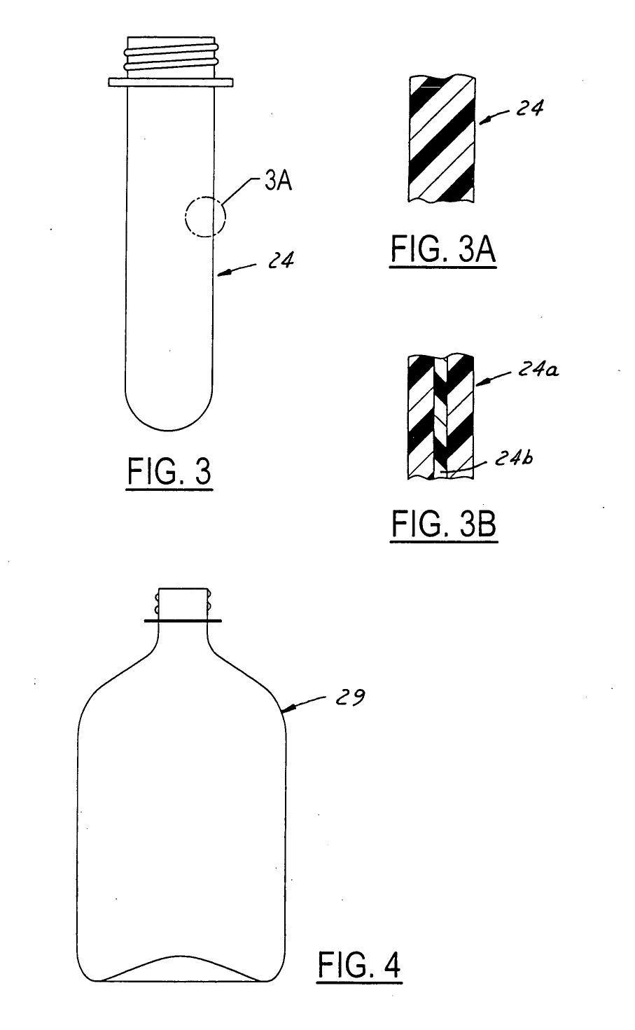

FIG. 1 illustrates a process 10 for manufacturing preforms in accordance with a presently preferred embodiment of the invention. A polyester resin such as PET is produced in a reactor 12 by otherwise conventional melt phase polymerization. A gear pump 14 or the like meters a continuous flow of polyester resin in melt phase from the outlet of reactor 12 to a stage 16 for compression molding container preforms. Compression molding stage 16 may be as disclosed in U.S. Pat. No. 5,866,177 or U.S. Pat. No. 6,349,838, the disclosures of which are incorporated herein by reference. A series of compression molds 18 (FIGS. 2A and 2B) are provided on a suitable structure, such as a rotating turret, for compression molding preforms in a continuous operation. Each mold 18 includes a female mold cavity 20 and a male mold core 22. Molds 18 are presented in a continuous stream, such as by moving the molds in a closed path through sequential stages of operation. The continuous stream of melt phase polymer from pump 14 is severed into individual mold charges 23, and each mold charge is placed in sequence in a corresponding mold cavity 20. The mold charge severing and delivery structure may be as disclosed in either of the above-referenced U.S. patents. Each mold core 22 is then moved into the associated cavity 20 to compression mold a container preform 24 (FIGS. 2B and 3). Each mold core 22 is then retracted in turn, and the preform 24 is ejected or withdrawn from the mold cavity 20 or the mold core 22. (The preform mold cavity configurations illustrated in FIGS. 2A and 2B, the preform geometry illustrated in FIGS. 2B and 3, and the container geometry illustrated in FIG. 4 are intended to be generic in nature, with the mold cavity, preform and container geometries in and of themselves not forming part of the present invention.)

Preform 24 preferably is of monolayer construction (FIG. 3A) of a suitable polyester polymer such as PET or polyethylene naphthalate (PEN). The polyester polymer may also include process regrind. A particular advantage of the present invention is that the polyester resin may have a low intrinsic viscosity (IV), which reduces the cost of the preform and the container molded from the preform. Employing PET, for example, the polymer may have an intrinsic viscosity of 0.65 or less, as measured according to ASTM D-5225-92. Low IV PET containers molded from such polymers are suitable for use in low pressure, low temperature applications such as personal care and dry food products. As an alternative, otherwise conventional additives to raise the viscosity of the melt phase polyester can be added to the melt stream prior to compression molding stage 16. The preferred preform 24 is of monolayer wall construction, as illustrated in FIG. 3A. As a modification, a layering stage may be placed between pump 14 and compression molding stage 16 in FIG. 1 to produce a preform 24a (FIG. 3B) having one or more intermediate wall layers 24b. Such intermediate layers may comprise barrier layers of nylon or ethylene vinyl alcohol (EVOH), for example, to retard migration of carbon dioxide, oxygen, water vapor and/or flavorants through the wall of the final container.

Preforms 24 (or 24a) may be shipped to a packager for blow molding and filling in a process illustrated at 26 in FIG. 1. As an alternative, processes 10, 26 may be integrated into a single continuous process in which the preform intermediate products compression mold stage 16 are fed in a continuous operation to a blow mold stage 28, in which the individual preforms are blow molded into containers 29 (FIG. 4). Blow mold stage 28 in such an integrated process is itself a continuous process (as distinguished from a batch process), as illustrated for example in U.S. Pat. Nos. 5,683,729, 5,863,571 and 6,168,749. Intermediate dwell and/or conditioning stages may be included in blow mold stage 28 for conditioning the preforms, such as by crystallizing the preform finishes, cooling the preforms to desired blow mold temperature, tailoring the temperature profiles of the preforms to suitable blow mold conditions, etc. Containers blow molded at stage 28 are fed to a fill stage 30, at which the containers are filled with suitable product. The containers are then capped at 32. Fill stage 30 and cap stage 32 may be combined in a single filling and capping machine. The filled and capped containers may then be fed through a labeling stage 34 to shipment or inventory stage 36. Processes 10, 26 may be connected in a “through the wall” operation, in which the compression molded preform intermediate products of stage 16 are fed through a “wall” 38 that separates the compression molding operation of one business entity from the container blowing, filling, capping, labeling and shipping operation 26 of a second business entity. The filling, capping and labeling stages illustrated in FIG. 1 are a continuous in-line continuation of the blow molding stage to produce filled, capped and labeled containers of polyester polymer in a continuous operation.

There has thus been described a method of producing preforms for blow molding plastic containers that achieves all of the objects and aims previously set forth. The process of the present invention has been disclosed in conjunction with presently preferred embodiments thereof, and a number of additional modifications and variations have been discussed. Other modifications and variations will readily suggest themselves to persons of ordinary skill in the art. The invention is intended to embrace all such modifications and variations as fall within the spirit and broad scope of the appended claims.

1. A method of producing preforms for blow molding containers, which includes the steps of:
(a) producing polyester polymer by melt phase polymerization, and
(b) compression molding preforms of said polyester polymer without solidifying the polyester polymer prior to compression molding the preforms.

2. The method set forth in claim 1 wherein said step (a) includes producing a continuous flow of said polyester polymer in melt phase, and
wherein said step (b) includes dividing said continuous flow into individual compression mold charges in melt phase.

3. The method set forth in claim 2 wherein said step (b) includes: (b1) providing a continuous flow of compression mold cavities, (b2) placing each said mold charge into an associated cavity and (b3) compression molding said mold charge into a preform, such that there is a continuous flow of polyester polymer from said step (a) through said step (b) to produce a continuous flow of preforms following said step (b).

4. The method set forth in claim 3 including the step of: (c) cooling said preforms compression molded in said step (a).

5. The method set forth in claim 3 including the step, between said steps (a) and (b), of layering said polyester polymer in said continuous flow with at least one additional polymer to produce preforms in said step (b) having a layered wall.

6. The method set forth in claim 3 including the steps of:
(c) blow molding containers from said preforms,
(d) filling the containers with product, and
(e) capping the containers with said product captured therein,
said steps (c), (d) and (e) being a continuous in-line continuation of said steps (a) and (b) to produce filled and capped containers of polyester polymer in a continuous operation.

7. A method of producing preforms for blow molding plastic containers, which includes the steps of:
(a) producing a continuous flow of polyester polymer by melt phase polymerization,
(b) providing a continuous motion of preform compression mold cavities,
(c) dividing said continuous flow of polyester polymer into individual compression mold charges in melt phase,
(d) placing each said mold charge into an associated mold cavity, and
(e) compression molding each said mold charge into a preform,
such that there is a continuous flow of polyester polymer from said step (a) through said step (e) to produce a continuous flow of preforms in said step (e).
